(19) United States
(12) Patent Application Publication
(10) Pub. No.: US 2009/0084277 A1
(43) Pub. Date: Apr. 2, 2009

(54) PRESSURIZING DEVICE

(75) Inventor: Osamu Yanagimoto, Kobe-shi Hyogo (JP)

Correspondence Address: BRYAN CAVE POWELL GOLDSTEIN, ONE ATLANTIC CENTER FOURTEENTH FLOOR, 1201 WEST PEACHTREE STREET NW, ATLANTA, GA, 30309-3488, US

(73) Assignee: FALCOM INC., Kobe-shi Hyogo (JP)

(21) Appl. No.: 11/914,013

(22) PCT Filed: Aug. 31, 2005
(86) PCT No.: PCT/JP2005/015891

§ 371 Date: Nov. 9, 2007

(30) Foreign Application Priority Data
May 9, 2005 (JP) 2005-136323

(51) Int. Cl. B30B 1/32

(52) U.S. Cl. 100/269.05

(57) ABSTRACT

A pressurizing device comprising a connection mechanism (5) capable of connecting an output shaft (2) to an input shaft (3) so that they are not moved relative to each other and a fluid pressure mechanism (6) capable of hydraulically connecting the output shaft (2) to the input shaft (3) and increasing the energization of the input shaft (3) by the Pascal's principle when the output shaft (2) and the input shaft (3) are moved relative to each other to pressurize the output shaft (3) with high thrust. The connection mechanism (5) detects the contact of the output shaft (2) on the pressurized object and releases the connection of the output shaft (2) to the input shaft (3).

### PRIORITY CLAIM

This patent application is a U.S. National Phase of International Application No. PCT/JP2005/015891, filed Aug. 31, 2005, which claims priority to Japanese Patent Application No. 2005-136323, filed May 9, 2005, the disclosures of which are incorporated herein by reference in their entirety.

### FIELD

The present disclosure relates to a pressure apparatus in which high-speed movement and high-thrust pressurization are compatible on an output shaft.

### BACKGROUND

The present disclosure relates to a pressure apparatus in which high-speed movement and high-thrust pressurization are made compatible in spite of the use of a motor having a small capacity by adding a hydraulic pressure mechanism which makes use of Pascal's principle, that is, a booster mechanism to a screw feed type pressure apparatus driven by a motor (see, for example, International Patent Publication No. WO 02/055291).

As shown in FIG. 11, the pressure apparatus comprises a stationary part 10, an output shaft 20 supported on the stationary part 10 to be made slidable in an axial direction, an input shaft 30 supported on the output shaft 20 to be slidable coaxially with the output shaft 20, a ball screw type drive mechanism 40, which causes a motor (not shown) to directly act the input shaft 30 in the axial direction, a connecting mechanism 50, in which the output shaft 20 and the input shaft 30 are connected to each other by a connecting hook 501, a hydraulic pressure mechanism 60, which increases energization of the input shaft 30 according to Pascal's principle to transmit the same to the output shaft 20, and a control mechanism 70, which controls the operation of the hydraulic pressure mechanism 60.

A pressure receiving piston 201 is formed on the output shaft 20. A first fluid chamber A1 and a second fluid chamber A2, which are compartmented in the axial direction by the pressure receiving piston 201, are defined between the stationary part 10 and the output shaft 20. The first fluid chamber A1 and the second fluid chamber A2 are communicated to each other by communication passages 201a, which are formed on the pressure receiving piston 201. Accordingly, the pressure receiving piston 201 and the output shaft 20 can freely slide relative to the stationary part 10 without being little subjected to resistance by a fluid filled in the both fluid chambers A1, A2. Consequently, the output shaft 20 can be moved at high speed by the drive mechanism 40 in a state of being connected to the input shaft 30 by the connecting mechanism 50.

A pressure applying piston 301 is formed on the input shaft 30. A third fluid chamber A3 pressurized by the pressure applying piston 301 is formed between the output shaft 20 and the input shaft 30. The third fluid chamber A3 is communicated to the second fluid chamber A2 by communication holes 202a. Accordingly, by releasing connection by the connecting mechanism 50 and closing the communication passages 201a, the second fluid chamber A2 and the third fluid chamber A3 function as the hydraulic pressure mechanism 60 capable of transmitting energization of the input shaft 30 to the output shaft 20. A pressure applying area of the pressure applying piston 301 is set to be considerably smaller than a pressure receiving area of the pressure receiving piston 201. Therefore, energization of the input shaft 30 is increased according to Pascal's principle to pressurize the output shaft 20 at high thrust. In addition, when the output shaft 20 is pressurized at high thrust, the first fluid chamber A1 is compressed by the pressure receiving piston 201 to be increased in internal pressure. A pressure absorbing piston 101 is provided in the first fluid chamber A1 to absorb an increase in internal pressure.

The connecting mechanism 50 comprises the connecting hook 501 fixed to an upper surface of the input shaft 30, an engagement 502 provided concavely on an upper surface of the output shaft 20, and a connection hook return roller 503 fixed to an upper portion of the stationary part 10. A pawl is formed on a turning end of the connecting hook 501. As shown in FIG. 11, the pawl engages with the engagement 502 whereby the output shaft 20 and the input shaft 30 are connected to each other so as not to make relative movements. In this connected state, the input shaft 30 moves downward to thereby make the output shaft 20 move at high speed. When the input shaft 30 is stopped in movement after high-speed movement of the output shaft 20 to a predetermined position, for example, a position just before a tip end of the output shaft 20 abuts against a pressurized object, the output shaft 20 is moved downwardly of the input shaft 30 under the influence of an inertial force to stop as shown in FIG. 12. Thereby, the connecting hook 501 is disengaged from the engagement 502 and falls inside due to the bias of a spring (not shown) provided about an axis of turning with the result that connection of the output shaft 20 and the input shaft 30 is released. In addition, when the input shaft 30 returns to an uppermost end (FIG. 11), at which the input shaft 30 is disposed in its origin position, after a series of pressurizing actions are terminated, the connecting hook 501 is returned to a position, in which it engages with the engagement 502, by the connection hook return roller 503 to restore connection of the output shaft 20 and the input shaft 30.

The hydraulic pressure mechanism 60 comprises the control mechanism 70, which controls communication between an interior (the second fluid chamber A2 and the third fluid chamber A3) of the hydraulic pressure mechanism 60 and an outside (the first fluid chamber A1), that is, opening and closing of the communication passages 201a to control the operation of the hydraulic pressure mechanism 60. The control mechanism 70 comprises a pin-shaped valve element 701 and an auxiliary valve element 702. The valve elements 701 are supported slidably by support holes 202 provided on the output shaft 20 and the auxiliary valve elements 702 are supported slidably by support shafts 203 provided on the output shaft 20. When the output shaft 20 and the input shaft 30 are connected to each other by the connecting mechanism 50 to make no relative movements, the valve elements 701 retreat so as to open the communication passages 201a as shown in FIGS. 11 and 12 and the auxiliary valve elements 702 are caused by an attracting force provided by built-in magnets (not shown) to shut off communication between the second fluid chamber A2 and the third fluid chamber A3.

Connection by the connecting mechanism 50 is released and the input shaft 30 is moved downward whereby the control mechanism 70 begins the operation of the hydraulic pressure mechanism 60. Owing to downward movement of the input shaft 30, the pressure applying piston 301 raises a hydraulic pressure in the third fluid chamber A3 closed by the auxiliary valve elements 702. As the hydraulic pressure in the third fluid chamber A3 rises, the valve elements 701 are pushed down to close the communication passages 201a. Further, when a hydraulic pressure in the third fluid chamber A3 rises, the auxiliary valve elements 702 are pushed up to provide a communication between the second fluid chamber A2 and the third fluid chamber A3. Thereby, as shown in FIG. 13, the input shaft 30 provided with the pressure applying piston 301, which has a small pressure applying area, and the output shaft 20 provided with the pressure receiving piston 201, which has a large pressure receiving area, are connected hydraulically to each other to enable increasing energization of the input shaft 30 according to Pascal's principle to transmit the same to the output shaft 20. In addition, the magnets built in the auxiliary valve elements 702 are set in attracting force so that after the valve elements 701 closes the communication passages 201a, the auxiliary valve elements 702 provide a communication between the second fluid chamber A2 and the third fluid chamber A3. Also, pins (not shown) are provided upright on upper surfaces of the auxiliary valve elements 702. When the output shaft 20 returns to its origin position, the pins abut against an upper lid body 102 of the stationary part 10 and the auxiliary valve elements 702 are pushed down to an initial position, in which a communication between the first fluid chamber A1 and the second fluid chamber A2 is shut off.

In the case where the output shaft 20 in the pressure apparatus makes high-speed movement and high-thrust pressurization, the connecting mechanism 50 first connects between the output shaft 20 and the input shaft 30 to move the input shaft 30 to a predetermined position at high speed. Subsequently, the input shaft 30 is stopped in the predetermined position whereby the connecting hook 501 turns to release connection of the output shaft 20 and the input shaft 30 as shown in FIG. 12. Thereafter, when downward movement of the input shaft 30 is begun again, pressurization by the pressure applying piston 301 raises the internal pressure in the third fluid chamber A3. Owing to an increase in internal pressure in the third fluid chamber A3, the control mechanism 70 operates to cause the valve elements 701 to close the communication passages 201a and to cause the auxiliary valve elements 702 to provide a communication between the second fluid chamber A2 and the third fluid chamber A3 as shown in FIG. 13. A fluid pushed out from the third fluid chamber A3 by the pressure applying piston 301 having a small pressure applying area flows into the second fluid chamber A2 to push the pressure receiving piston 201, which has a large pressure receiving area, thereby pressurizing the output shaft 20 at high thrust.

When high-thrust pressurization is terminated, a fluid compressed in the first fluid chamber A1 causes a reaction force from the pressure absorbing piston 101 to push back the valve elements 701 to open the communication passages 201a. Thereby, a fluid can move to the first fluid chamber A1 from the second fluid chamber A2. Accordingly, by moving the input shaft 30 upward, the output shaft 20 can be returned to the origin position. When the output shaft 20 is returned to the origin position, the auxiliary valve elements 702 are pushed down to an initial position, in which a communication between the second fluid chamber A2 and the third fluid chamber A3 is shut off.

The pressure apparatus makes high-speed movement and high-thrust pressurization compatible in spite of the use of a motor having a small capacity, but involves the following problems.

Firstly, after the input shaft 30 stops the output shaft 20 makes an overstroke due to an inertial force to cause the connecting hook 501 to disengage from the engagement 502 whereby connection by the connecting mechanism 50 is released. Accordingly, the setting must be made beforehand so that the input shaft 30 is stopped before the output shaft 20 abuts against a pressurized object W, but this gives rise to the need of taking account of a magnitude of an overstroke of the output shaft 20. On the other hand, since a magnitude of an overstroke of the output shaft 20 due to an inertial force is varied according to the speed just before stoppage or the like, it takes much time to set a point of stoppage of the input shaft 30 in a set-up change in which a pressurized object is changed.

Secondly, there is an abnormality generated in some cases in which a foreign object bites during downward movement of the input shaft 30 to lock the output shaft 20. In the case where such an abnormality is generated there is a fear that energization by the input shaft 30 is transmitted to the connecting mechanism 50 which will cause breakage, such as deformation of the connecting hook 501, etc.

Thirdly, after the termination of high-thrust pressurization, there is a need of having the connection hook return roller 503 returning the connecting hook 501 to a position in engagement with the engagement 502 in order to restore connection by the connecting mechanism 50, but there is a need of surely returning the input shaft 30 to an origin position which brings about loss in time to obstruct an improvement in production efficiency since the connection hook return roller 503 is provided on an upper portion of the stationary part 10.

In view of the problems, the present disclosure provides a pressure apparatus in which it is unnecessary to spend a long time beforehand in setting a point of switchover to high-thrust pressurization from high-speed movement. The apparatus is not broken when an abnormality in which an output shaft is locked is generated. It is unnecessary to return an input shaft to an origin position set at an uppermost end of stroke after high-thrust pressurization is terminated and which is excellent in production efficiency.

### SUMMARY

The present disclosure describes several exemplary embodiments of the present invention.

One aspect of the present disclosure provides a pressure apparatus, comprising a) a stationary part; b) an output shaft supported on the stationary part to be slidable in an axial direction; c) an input shaft supported on the output shaft to be slidable coaxially with the output shaft; d) a drive mechanism capable of moving the input shaft in the axial direction; e) a connecting mechanism capable of connecting the output shaft and the input shaft to each other so as to inhibit relative movements; and, f) a hydraulic pressure mechanism which connects the output shaft and the input shaft hydraulically to each other and can increase energization of the input shaft according to Pascal's principle to subject the output shaft to high-thrust pressurization when the output shaft and the input shaft move relative to each other. When the input shaft moves the output shaft connected thereto by the connecting mechanism, the connecting mechanism releases connection of the output shaft and the input shaft detecting that the output shaft abuts against a pressurized object.

Another aspect of the present disclosure provides a pressure apparatus, comprising a) a stationary part including a hollow cylinder body formed on both ends thereof in a direction of cylinder axis with a first through-hole and a second through-hole; b) an output shaft including a hollow cylinder body slidably supported by the first through-hole and the second through-hole and defining a first fluid chamber and a second fluid chamber between the output shaft and the stationary part; c) a pressure receiving piston formed integrally on the output shaft to compartment the first fluid chamber and the second fluid chamber and provided with a communication passage which provides a communication between the first fluid chamber and the second fluid chamber; d) an input shaft slidably supported on the output shaft to form a third fluid chamber which is communicated to the second fluid chamber between the input shaft and the output shaft; d) a pressure applying piston integrally formed on the input shaft to expand and contract the third fluid chamber as the input shaft reciprocates, the pressure applying piston having a smaller pressure applying area than a pressure receiving area of the pressure receiving piston; e) a drive mechanism capable of moving the input shaft in a slide direction; f) a connecting mechanism capable of connecting the output shaft and the input shaft to each other so as to inhibit relative movements; and, g) a control mechanism which maintains the communication passage open when connection by the connecting mechanism is provided and closes the communication passage when connection by the connecting mechanism is released. When the input shaft moves the output shaft connected thereto by the connecting mechanism, the connecting mechanism releases connection of the output shaft and the input shaft detecting that the output shaft abuts against a pressurized object thereby putting the output shaft in a state capable of high-thrust pressurization.

With the pressure apparatus of the present disclosure, when the output shaft and the input shaft are connected to each other so as to inhibit relative movements and moved, it is detected that the output shaft abuts against a pressurized object and then connection of the output shaft and the input shaft is released so that it is unnecessary to spend substantial time in setting a point of switchover to high-thrust pressurization from high-speed movement. Accordingly, there is produced an excellent effect that a set-up change can be completed in a short period of time even when a point of switchover is varied in exchanging a pressurized object W.

Since detecting that a reaction force in a reverse direction to a direction of movement is generated on the output shaft, connection of the output shaft and the input shaft is released, one exemplary embodiment of the pressure apparatus provides that, even in the case where an abnormality in which the output shaft is locked is generated in the course of high-speed movement of the output shaft, connection of the output shaft and the input shaft by the connecting mechanism is released at that point of time, so that it is possible to avoid a situation in which the connecting mechanism 5 is acted by a large load to break.

Since when a reaction force in a reverse direction to a direction of movement is generated on the output shaft, the action of the reaction force releases connection by the connecting mechanism, another exemplary aspect of the pressure apparatus ensures that there is no need of providing a drive source for release of connection so that it is possible to avoid complication of the apparatus.

Since the first connecting member operates the second connecting member owing to the action of the reaction force to release engagement of the first connecting member and the second connecting member, which causes engagement of the output shaft and the input shaft, a further exemplary aspect of the pressure apparatus ensures that there is no need of separately providing a member for actuation of the second connecting member, thus reducing the number of parts.

Since a holding force for holding of the second connecting member can be regulated, an additional exemplary aspect of the pressure apparatus makes it possible to finely regulate a preload, which the output shaft applies on a pressurized object before high-thrust pressurization is begun, depending upon a pressurized object.

Since by returning the input shaft to a position before high-thrust pressurization is begun, from a state in which connection of the output shaft and the input shaft by the connecting mechanism is released, connection by the connecting mechanism is automatically restored, a further exemplary aspect of the pressure apparatus makes it unnecessary to return the output shaft to an origin position in order to restore connection of the output shaft and the input shaft by the connecting mechanism, and so it is possible to shorten a total time for work of pressurization, thus enabling an improvement in production efficiency.

Since by returning the input shaft to a position before high-thrust pressurization is begun, from a state in which connection of the output shaft and the input shaft by the connecting mechanism is released, the first connecting member engages with the second connecting member to restore connection by the connecting mechanism, another exemplary aspect of the pressure apparatus makes it unnecessary to return the output shaft to an origin position in order to restore connection of the output shaft and the input shaft by the connecting mechanism, and so it is possible to shorten a total time for work of pressurization, thus enabling an improvement in production efficiency.

Since the first connecting member turns the second connecting member in a reverse direction to thereby restore engagement, a further exemplary aspect of the pressure apparatus ensures that there is no need of separately providing a drive source or a member for restoration of connection, and so it is possible to avoid complication of the apparatus.

Since the hydraulic pressure mechanism is constructed to be switched over to a state of enabling high-thrust pressurization detecting that connection by the connecting mechanism is released, another exemplary aspect of the pressure apparatus ensures that, when the input shaft moves the output shaft, connection of the output shaft and the input shaft is released detecting that the output shaft abuts against a pressurized object, and successively the hydraulic pressure mechanism is switched over to a state capable of high-thrust pressurization with the result that a series of pressurizing actions are smoothly performed.

Since the second fluid chamber and the third fluid chamber are connected hydraulically to each other at all times and when connection by the connecting mechanism is released, the control mechanism detects flow of a fluid, which is pushed out into the second fluid chamber from the third fluid chamber by energization of the input shaft, to close the communication passage, an additional exemplary aspect of the pressure apparatus provides that, when the input shaft moves the output shaft, connection of the output shaft and the input shaft is released detecting that the output shaft abuts against a pressurized object, and successively the hydraulic pressure mechanism is switched over to a state capable of high-thrust pressurization with the result that a series of pressurizing actions are smoothly performed.

### BRIEF DESCRIPTION OF THE DRAWINGS

FIG. 1 is a cross-sectional view showing a pressure apparatus according to an exemplary embodiment in a state before an output shaft begins high-speed movement and taken along the line A-A as shown in FIG. 2;

FIG. 2 is a cross-sectional view showing the pressure apparatus of FIG. 1 in a state before the output shaft begins high-speed movement and taken along the line B-B as shown in FIG. 1;

FIG. 3 is a view showing the pressure apparatus according to one exemplary embodiment in a state just after the output shaft terminates high-speed movement;

FIG. 4 is a view showing the pressure apparatus according to an exemplary embodiment in a state just after the output shaft begins high-thrust pressurization;

FIG. 5 is a view showing the pressure apparatus according to an exemplary embodiment in a state just after the output shaft terminates high-thrust pressurization;

FIG. 6 is a view illustrating the operation of a control mechanism in the pressure apparatus according to an exemplary embodiment when the output shaft shifts to high-thrust pressurization from high-speed movement;

FIG. 7 is a view showing a state of the pressure apparatus according to an exemplary embodiment when communication passages are opened after the output shaft terminates high-thrust pressurization;

FIG. 8 is a view showing flow of a fluid in the pressure apparatus according to an exemplary embodiment when an input shaft moves upward together with the output shaft to return to an original state;

FIG. 9 is an enlarged view showing the pressure apparatus according to an exemplary embodiment in a state in which a connecting mechanism connects the output shaft and the input shaft to each other;

FIG. 10 is an enlarged view showing the pressure apparatus according to an exemplary embodiment in a state in which the connecting mechanism releases connection of the output shaft and the input shaft;

FIG. 11 is a cross-sectional view showing a conventional pressure apparatus in a state before an output shaft begins high-speed movement;

FIG. 12 is a cross-sectional view showing the conventional pressure apparatus in a state just after the output shaft terminates high-speed movement; and

FIG. 13 is a cross-sectional view showing the conventional pressure apparatus in a state just after the output shaft terminates high-thrust pressurization.

### DESCRIPTION OF REFERENCE NUMERALS AND SIGNS

1: stationary part
2: output shaft
3: input shaft
4: drive mechanism
5: connecting mechanism
6: hydraulic pressure mechanism
7: control mechanism
8: pressure absorbing mechanism
11a: first through-hole
11b: second through-hole
22: pressure receiving piston
22a: communication passage
32: pressure applying piston
511: stationary hook body (first connecting member)
52: turning hook
521: turning hook body (second connecting member)
71: valve element
711: input portion
712: closed portion
72: support portion
721a: recess
722: magnet
73a: passage path
A1: first fluid chamber
A2: second fluid chamber
A3: third fluid chamber
W: pressurized object

### DETAILED DESCRIPTION

One exemplary embodiment of the present disclosure is described below with reference to the accompanying drawings.

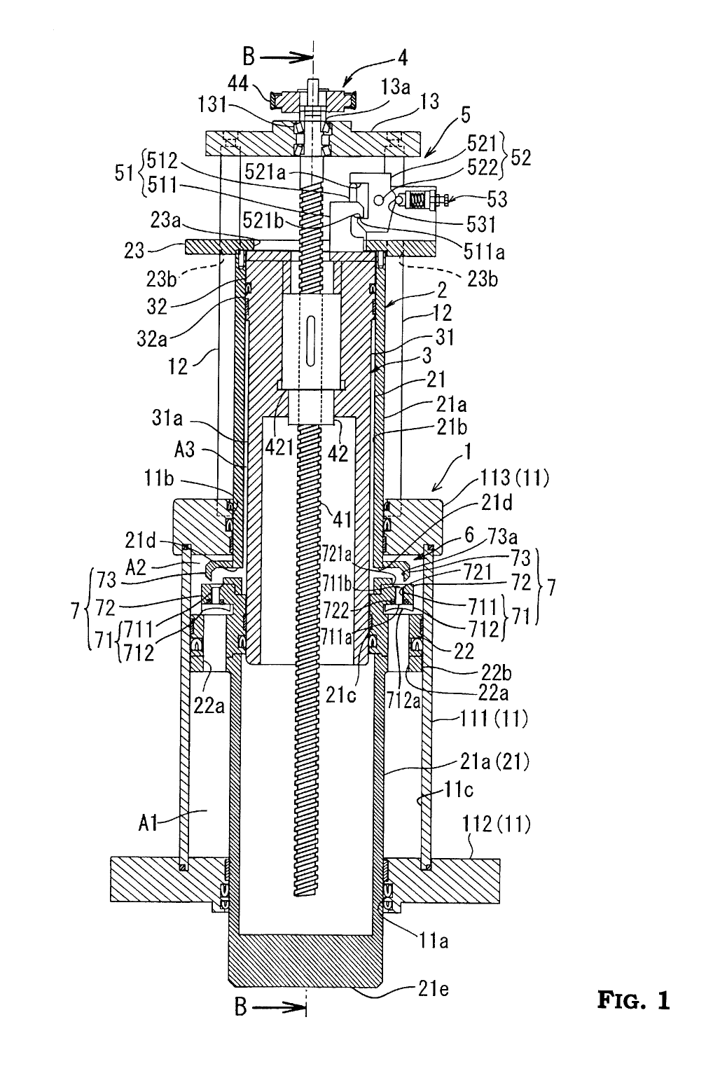

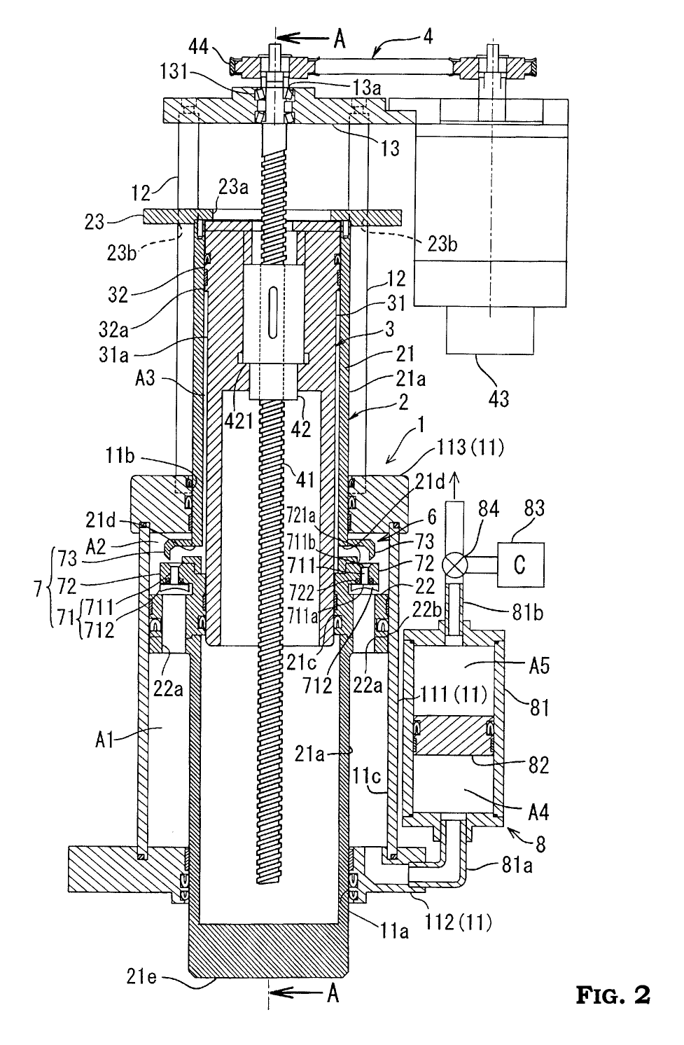

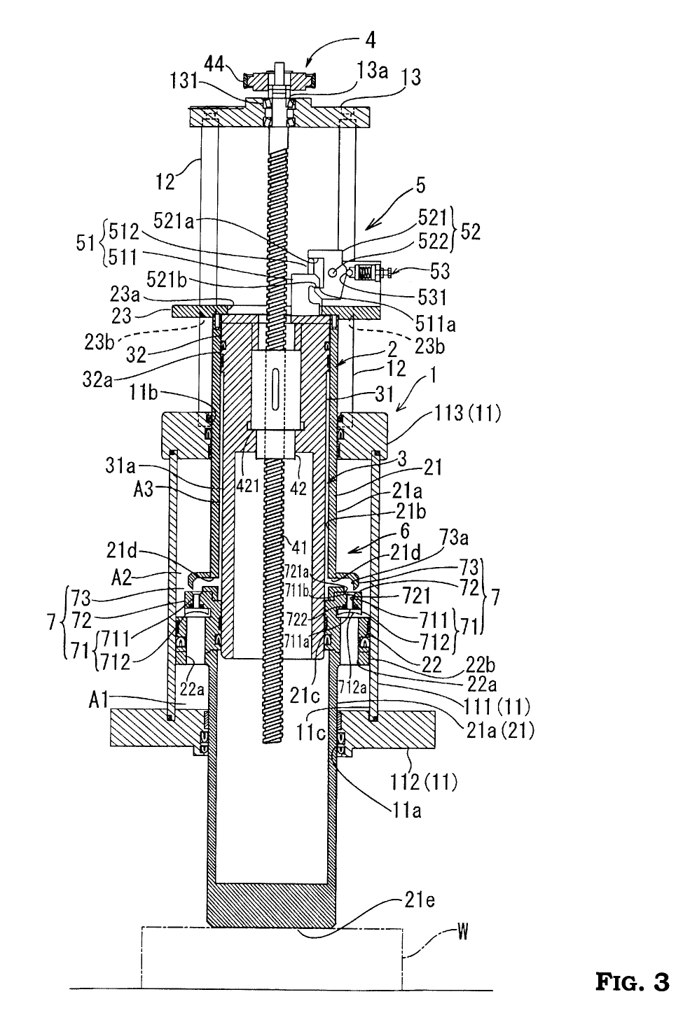

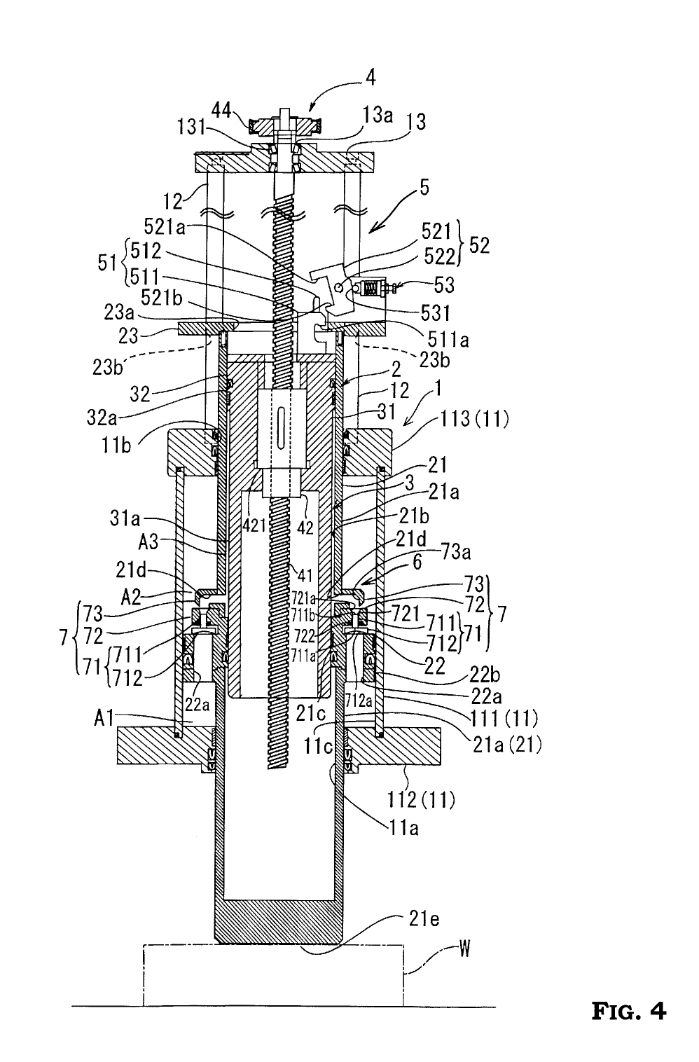

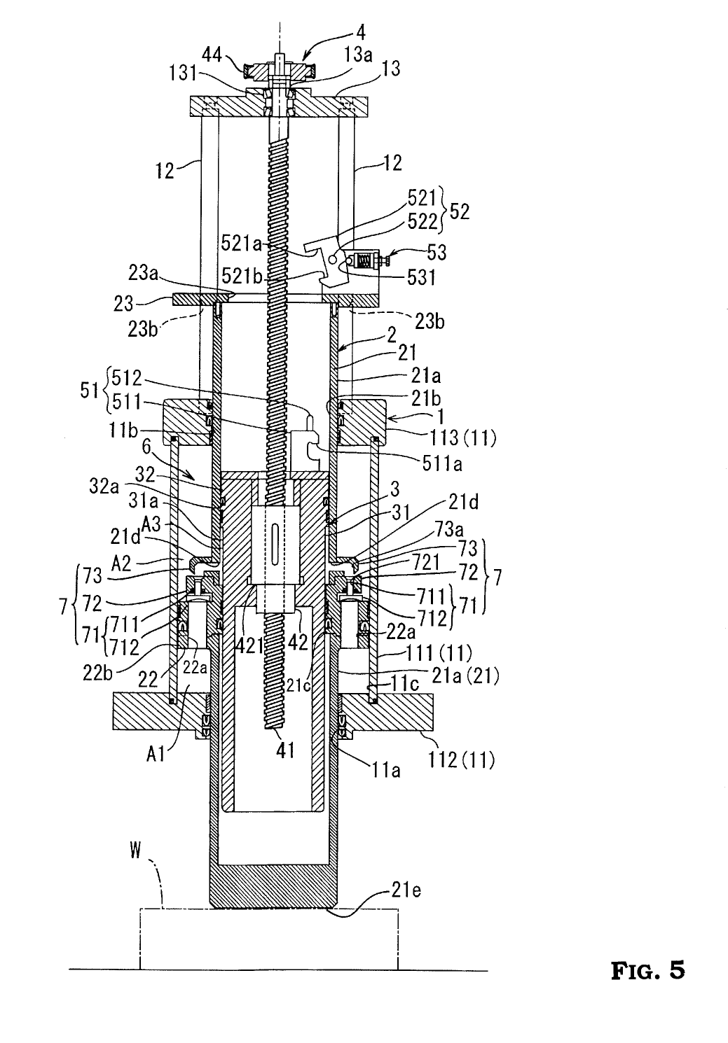

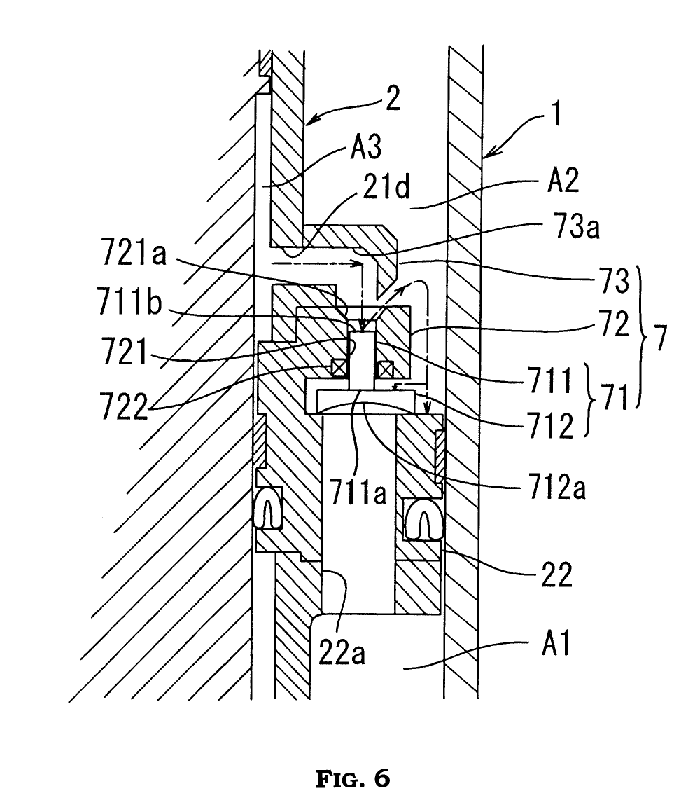

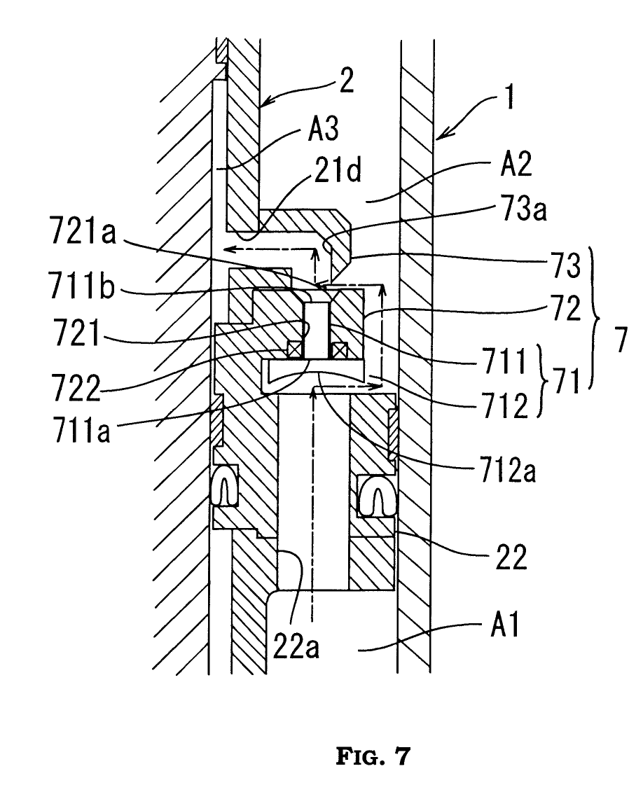

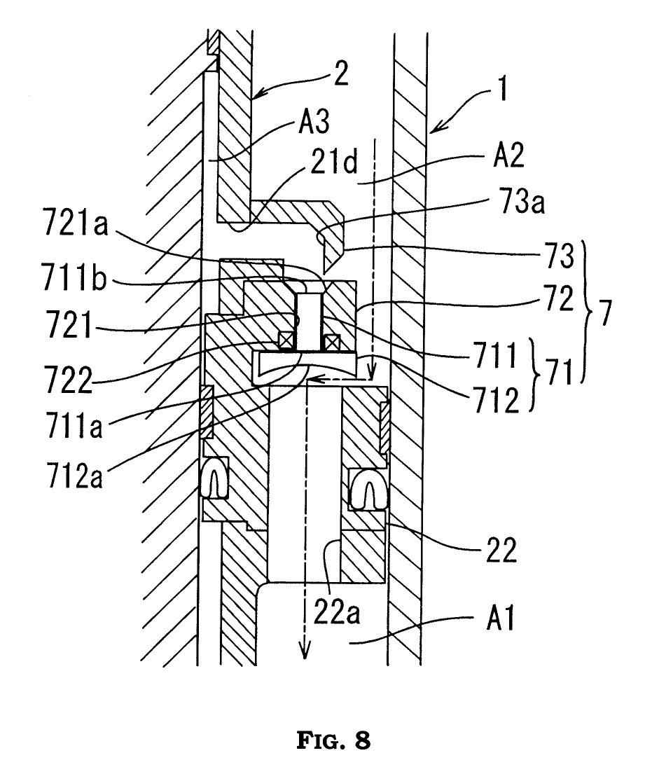

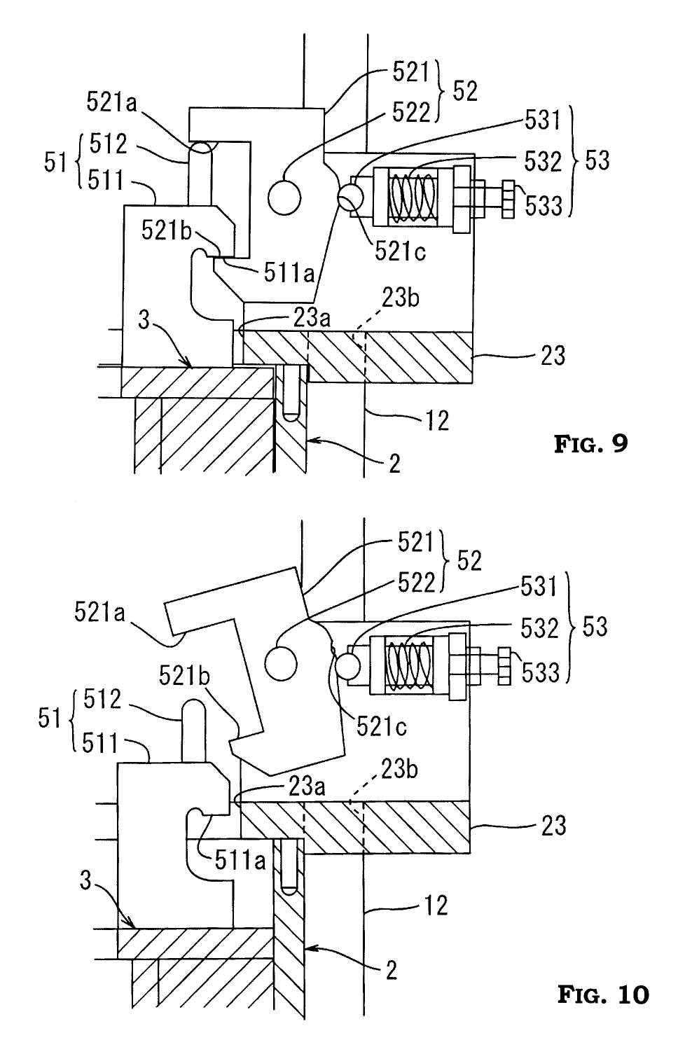

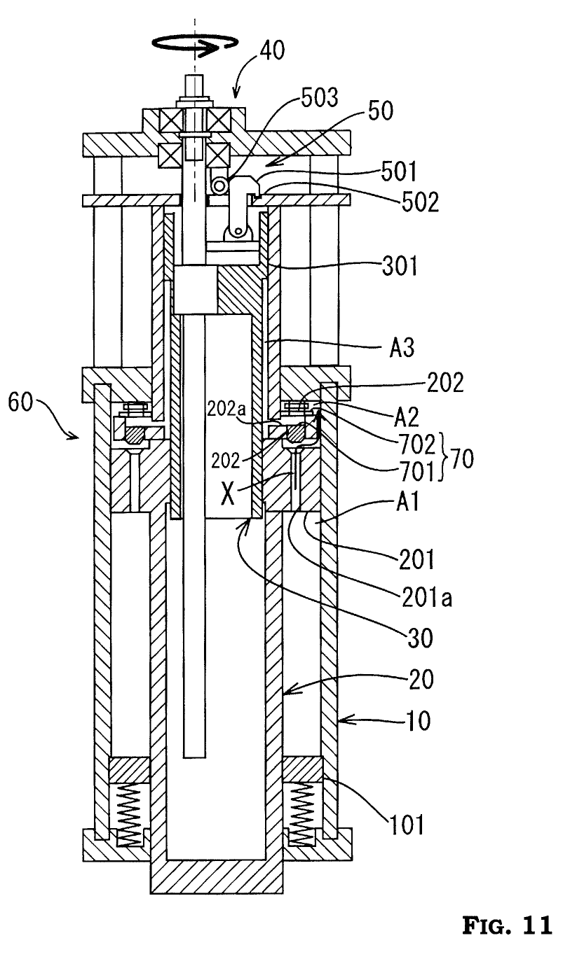

FIGS. 1-10 are cross-sectional views showing an example of a pressure apparatus, in which the present disclosure is embodied. FIGS. 1 and 2 are views showing a state before an output shaft 2 begins high-speed movement, FIG. 1 being a view showing a cross section taken along the line A-A in FIG. 2, and FIG. 2 being a view showing a cross section taken along the line B-B in FIG. 1. FIGS. 3-5 show a cross section corresponding to FIG. 1, FIG. 3 being a view showing a state after the output shaft 2 terminates high-speed movement, FIG. 4 being a view showing a state just after the output shaft 2 begins high-thrust pressurization, and FIG. 5 being a view showing a state just after the output shaft 2 terminates high-thrust pressurization. FIG. 6 is a view illustrating the operation of the control mechanism 7 when the output shaft 2 shifts to high-thrust pressurization. FIG. 7 is a view showing a state when communication passages 22a are opened after the output shaft 2 terminates high-thrust pressurization, and FIG. 8 is a view showing flow of a fluid when an input shaft 3 moves upward together with the output shaft 2 and returns to an original state. FIGS. 9 and 10 are enlarged views showing a connecting mechanism 5, FIG. 9 showing a state, in which the output shaft 2 and the input shaft 3 are connected to each other by the connecting mechanism 5, and FIG. 10 showing a state, in which connection of the output shaft 2 and the input shaft 3 is released.

In addition, an explanation will be given below referring to upward and downward, and left and right directions in the drawings for the sake of convenience, but posture/sense of installation of the pressure apparatus is not limited thereby and the pressure apparatus may be installed in a different posture/sense from that in the following descriptions, for example, in a horizontal direction.

As shown in FIGS. 1-5, the pressure apparatus according to one exemplary embodiment comprises a stationary part 1, the output shaft 2 inserted through and supported on the stationary part 1 to be slidable in an axial direction, the input shaft 3 inserted through and supported on the output shaft 2 to be slidable coaxially with the output shaft 2, a drive mechanism 4 capable of reciprocating the input shaft 3 in the axial direction, the connecting mechanism 5 capable of connecting the output shaft 2 and the input shaft 3 to each other so as to inhibit relative movements, a hydraulic pressure mechanism 6, which hydraulically connects the output shaft 2 and the input shaft 3 to each other at all times and can increase energization of the input shaft 3 according to Pascal's principle to transmit the same to the output shaft 2 in a state, in which connection by the connecting mechanism 5 is released, a control mechanism 7, which controls communication between inside and outside the hydraulic pressure mechanism 6, and a pressure absorbing mechanism 8 connected to the stationary part 1 to permit pressure in a fluid chamber (first fluid chamber A1), which is compressed when the output shaft 2 is subjected to high-thrust pressurization, to release.

With the pressure apparatus, as shown in FIG. 3, the input shaft 3 is connected to the output shaft 2 by the connecting mechanism 5 in a manner not to move relative thereto whereby the output shaft 2 can be moved at high speed with low thrust immediately before the output shaft 2 abuts against a pressurized object W. Also, as shown in FIG. 4, by releasing connection by the connecting mechanism 5 and moving the input shaft 3 relative to the output shaft 2, it is possible to pressurize the output shaft 2 at high thrust while at low speed. That is, it is possible to exhibit substantially the same function as that of a pressure apparatus, which performs low-thrust high-speed movement and low-speed high-thrust pressurization and uses a motor of a large capacity to realize high-speed/high-thrust.

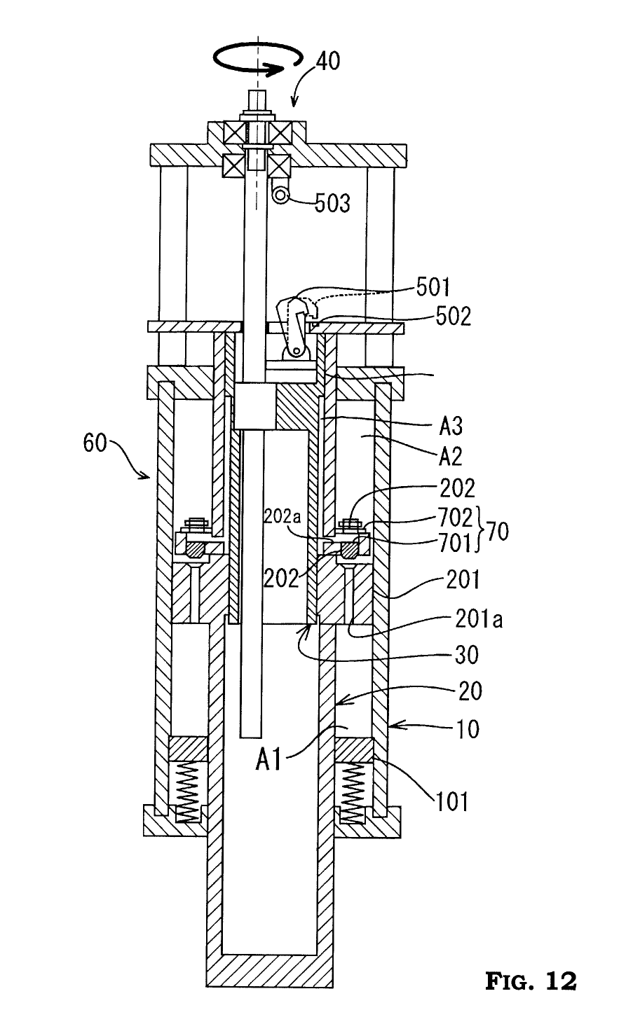

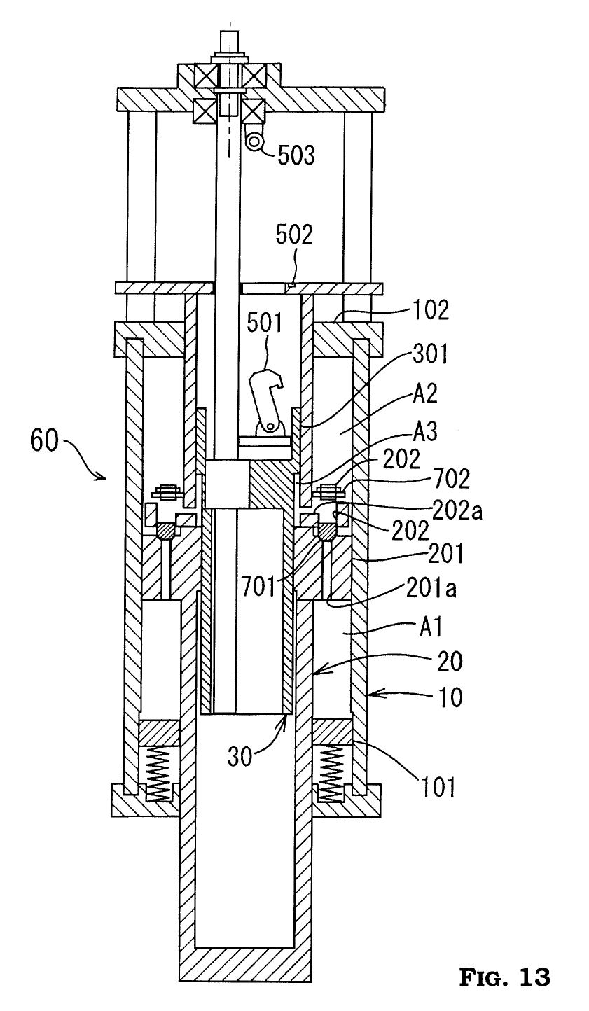

While the function described above is the same as that of a conventional pressure apparatus (FIGS. 11-13), the present pressure apparatus provides the connecting mechanism 5 and the control mechanism 7 with those features, which are not found in the conventional pressure apparatus. The construction and operation of the present pressure apparatus as well as the features will be described in detail.

### (Stationary Part 1)

As shown in FIGS. 1 and 2, the stationary part 1 includes a stationary part body 11 in the form of a hollow cylinder, a plurality of guide rods 12 fixed to the stationary part body 11 to extend in a direction of a cylinder axis (vertical direction in the figure) of the stationary part body 11, and a plate-shaped bearing part 13 fixed to and supported on upper ends of the guide rods 12, and is mounted on a stationary side.

### (Stationary Part Body 11)

The stationary part body 11 includes a cylinder body 111 having a circular-shaped inner cross section and being in the form of a straight pipe, and a first lid body 112 and a second lid body 113, which are mounted to cover openings at both upper and lower ends of the cylinder body 111. The first lid body 112 and the second lid body 113 are formed with a first through-hole 11a and a second through-hole 11b, which support the output shaft 2 slidably. The first through-hole 11a and the second through-hole 11b are formed to be smaller in diameter than an inner peripheral diameter of the cylinder body 111, and have a plurality of circumferential grooves engraved at intervals in the direction of cylinder axis on inner peripheral surfaces thereof. A sealing material formed of a resin and having a U-shaped cross section, and a slip material formed of a metal are fitted into the respective circumferential grooves.

### (Guide Rod 12)

The guide rods 12 are provided upright in plural to surround the second through-hole 11b on the second lid body 113 to extend upward. The guide rods 12 have upper ends thereof supporting and fixing the bearing part 13 thereto and have intermediate portions thereof slidably supporting a sliding part 23, which is mounted to an upper portion of the output shaft 2, to guarantee smooth, vertical movements of the output shaft 2.

### (Bearing Part 13)

The bearing part 13 is a plate-shaped member, a periphery of which is fixed to and supported on the guide rods 12, and a center of which is formed with a through-hole 13a. A roller bearing 131 is mounted in the through-hole 13a to rotatably support a ball screw 41, which constitutes the drive mechanism 4. A servomotor 43 as well as the ball screw 41 is connected and fixed to the bearing part 13 as shown in FIG. 2.

### (Output Shaft 2)

The output shaft 2 includes an output shaft body 21 in the form of a hollow cylinder, an annular pressure receiving piston 22 formed integrally on an axially intermediate portion of the output shaft body 21 and provided with a plurality of communication passages 22a, which are formed to extend therethrough in the direction of cylinder axis, and a plate-shaped slide part 23 mounted to a rear end (upper end in the figure) of the output shaft body 21 and formed centrally thereof with a through-hole 23a.

### (Output Shaft Body 21)

As shown in FIGS. 4 and 5, the output shaft body 21 is an output member, a tip end 21e of which is pushed against the pressurized object W to perform a pressure processing. The output shaft body 21 has an outer peripheral surface 21a thereof supported slidably by the first through-hole 11a and the second through-hole 11b and defines a first fluid chamber A1 and a second fluid chamber A2 between the outer peripheral surface 21a and an inner peripheral surface 11c of the stationary part body 11 (the cylinder body 111). The first fluid chamber A1 and the second fluid chamber A2 are filled with a fluid (oil). The fluid is sealed by a sealing material, which is fitted into inner peripheral surfaces of the first through-hole 11a and the second through-hole 11b, not to leak outside the stationary part body 11. In addition, communication holes 21d are formed on a side of the output shaft body 21 above the pressure receiving piston 22 to provide a communication between the second fluid chamber A2 and a third fluid chamber A3 described later. The communication holes 21d are formed in plural to correspond to each of the plurality of the communication passages 22a provided at predetermined intervals circumferentially of the pressure receiving piston 22.

### (Pressure Receiving Piston 22)

The pressure receiving piston 22 is formed to project radially outwardly of the outer peripheral surface 21a of the output shaft body 21 and to have its outer peripheral surface 22b extending along the inner peripheral surface 11c of the stationary part body 11, thus compartmenting the first fluid chamber A1 and the second fluid chamber A2. A sealing material and a slip material are fitted onto the outer peripheral surface 22b of the pressure receiving piston 22 to provide for sealing so that the fluid does not leak between the first fluid chamber A1 and the second fluid chamber A2 from contact surfaces of the stationary part body 11 and the pressure receiving piston 22. However, when the stationary part 1 and the output shaft 2 slide relative to each other to slide the pressure receiving piston 22 vertically, the communication passages 22a are left open whereby the fluid in the first fluid chamber A1 and the second fluid chamber A2 can move therebetween. An inner peripheral surface 21c of that portion of the output shaft body 21, on which the pressure receiving piston 22 is formed, is smaller in diameter than an inner peripheral surface 21b except the portion.

### (Slide Part 23)

The slide part 23 is a plate-shaped body formed centrally thereof with the through-hole 23a and fixed to the upper end of the output shaft body 21 by a bolt or the like. The through-hole 23a is provided to permit the ball screw 41 and a stationary hook 51 of the connecting mechanism 5 fixed to the input shaft 3 to extend therethrough. A turning hook 52, which constitutes the connecting mechanism 5 together with the stationary hook 51, is fixed to an upper surface of the slide part 23. A plurality of support holes 23b, which support the plurality of guide rods 12 described above, respectively, slidably, are formed on a peripheral edge of the slide part 23 to extend therethrough. In addition, when the input shaft 3 moves upward after high-thrust pressurization is terminated, an upper end of the input shaft 3 abuts against a peripheral edge of the through-hole 23a of the slide part 23 to push up the output shaft 2.

### (Input Shaft 3)

The input shaft 3 includes a cylindrical-shaped input shaft body 31 and an annular pressure applying piston 32 formed integral with an upper portion of the input shaft body 31.

### (Input Shaft Body 31)

The input shaft body 31 is a cylindrical body extended through an interior of the output shaft body 21. An outer peripheral surface 31a of the input shaft body 31 is slidably supported on the inner peripheral surface 21c of the output shaft body 21 and an outer peripheral surface 32a of the pressure applying piston 32 formed integral therewith is slidably supported on the inner peripheral surface 21b of the output shaft body 21. Thereby, the input shaft 3 is made axially slidable relative to the output shaft 2 and the third fluid chamber A3 is defined between the outer peripheral surface 31a of the input shaft body 31 and the inner peripheral surface 21b of the output shaft body 21. Sealing materials and slip materials are fitted onto the inner peripheral surface 21c of the output shaft body 21 and the outer peripheral surface 32a of the pressure applying piston 32, thereby sealing the fluid in the third fluid chamber A3 and ensuring smooth sliding of the input shaft body 31.

### (Pressure Applying Piston 32)

The pressure applying piston 32 reciprocates the input shaft 3 vertically relative to the output shaft 2 to thereby expand or compress the third fluid chamber A3. The input shaft 3 is moved downward relative to the output shaft 2 whereby the pressure applying piston 32 compresses the third fluid chamber A3 to enable the fluid in the third fluid chamber A3 to be pushed into the second fluid chamber A2 from the communication holes 21d. Since a pressure applying area of the pressure applying piston 32 is set to be considerably small as compared with a pressure receiving area of the pressure receiving piston 22, energization of the pressure applying piston 32 (the input shaft 3) is increased according to Pascal's principle when transmitted to the pressure receiving piston 22 (the output shaft 2).

### (Drive Mechanism 4)

The drive mechanism 4 includes the ball screw 41 rotationally supported on the bearing part 13, a ball bush 42 fixed inside the input shaft body 31 to combine with the ball screw 41, the servomotor 43 connected and fixed to the bearing part 13, and a belt 44 for transmission of a driving force of the servomotor 43 to the ball screw 41, and the input shaft 3 is made axially movable.

### (Ball Screw 41 and Ball Bush 42)

The ball screw 41 combines with the ball bush 42, which is fixed to the input shaft 3, to constitute a rotation-direct acting conversion mechanism, which is rotationally driven by the servomotor 43 to reciprocate (direct act) the input shaft 3 axially. A grease supply unit 421 for supplying of grease to the ball bush 42 is provided above the ball bush 42. The ball bush 42 is arranged in a position offset from a center of the input shaft body 31 so as not to rotate the input shaft 3 together.

### (Servomotor 43 and Belt 44)

The servomotor 43 is fixed to the bearing part 13 to enable the input shaft 3 to reciprocate to stop in a preset optional position. The belt 44 is a toothed belt wound around pulleys, respectively, mounted to the ball screw 41 and the servomotor 43.

### (Connecting Mechanism 5)

As shown in FIGS. 1-5, the connecting mechanism 5 includes the stationary hook 51 fixed to an upper surface of the input shaft 3, the turning hook 52 fixed to the upper surface of the slide part 23 to enable turning, and an engagement 53 fixed to the upper surface of the slide part 23 to maintain the turning hook 52 in a state of engaging with the stationary hook 51. As shown in FIG. 9, the connecting mechanism 5 has the stationary hook 51 and the turning hook 52 engaging with each other to enable connecting the output shaft 2 and the input shaft 3 to each other so as to inhibit relative movements. Also, as shown in FIG. 10, the connecting mechanism 5 permits the turning hook 52 to turn to enable releasing the connection.

### (Stationary Hook 51 and Turning Hook 52)

The stationary hook 51 includes a stationary hook body 511, which is substantially C-shaped and forms a first connecting member, and a return pin 512 provided upright on an upper surface of the stationary hook body 511. The turning hook 52 includes a turning hook body 521, which is substantially C-shaped and forms a second connecting member, and a support shaft 522, which fixes the turning hook body thereto to enable turning. The stationary hook body 511 and the turning hook body 521 are fixed so that C-shaped openings thereof face each other, a tip end of the return pin 512 is made engageable with an upper end 521a of an opening of the turning hook body 521, and a lower surface 511a of an upper end of the stationary hook body 511 is made engageable with a lower end 521b of the opening of the turning hook body 521 as shown in FIG. 9.

As shown in FIG. 9, the turning hook body 521 is formed on a back thereof with an engaged portion (recess) 521c, with which an engagement ball 531 of the engagement 53 engages in a state, in which the stationary hook 51 and the turning hook 52 engage with each other. As shown in FIG. 10, a lower portion of the engaged portion 521c is cut obliquely in order to restrict resistance generated when the engagement ball 531 is caused to engage with the engaged portion 521c from a state, in which engagement of the stationary hook body 511 and the turning hook body 521 is released, to a small magnitude. Thereby, while connection by the connecting mechanism 5 is not released unless a force being large to some measure acts, the connection can be restored by application of a slight force.

### (Engagement 53)

As shown in FIG. 9, the engagement 53 includes an engagement ball 531, which engages with the engaged portion 521c in a state, in which the stationary hook 51 and the turning hook 52 engage with each other, to hold the same so that the turning hook 52 does not turn in an engagement releasing direction, and a regulating bolt 533 for regulation of a pushing force of a push member 532, with which the engagement ball 531 is pushed elastically against the back of the turning hook body 521, that is, a holding force, which holds the turning hook 52 in a state of engaging with the stationary hook 51. In addition, the pushing force of the push member 532 is regulated so that the engagement ball 531 is not disengaged from the engaged portion 521c unless a large reaction force acts on the output shaft 2, even when the input shaft 3 is moved downward from a state shown in FIG. 9.

### (Action of Connecting Mechanism 5)

As described above, even when the input shaft 3 is moved downward from an initial state (FIG. 1), in which the stationary hook 51 and the turning hook 52 engage with each other, the connecting mechanism 5 maintains a state, in which the output shaft 2 and the input shaft 3 are connected to each other. Accordingly, the output shaft 2 together with the input shaft 3 can move to a position shown in FIG. 3 at high speed. Here, when the output shaft 2 is caused to abut against the pressurized object W at high speed an impact thereby causes damage to the pressurized object W and the pressure apparatus itself in some cases so that the output shaft is once stopped in a position shown in FIG. 3 and then begins downward movement again to abut against the pressurized object slowly. In addition, the servomotor 43 is adopted as a drive source for the input shaft 3 and there is no need for taking account of a magnitude of an overstroke of an output shaft like the conventional pressure apparatus, so that it is possible to readily and exactly set a position of stoppage.

When energization by the input shaft 3 is given after the output shaft 2 abuts against the pressurized object W a reaction force is generated on the output shaft 2 to relatively push up the output shaft 2 in a reverse direction to a direction in which the input shaft 3 is moved. Owing to the action of the reaction force on the output shaft 2 the lower end 521b of the turning hook body 521 fixed to the output shaft 2 is pushed down by the upper end 511a of the stationary hook body 511 fixed to the input shaft 3. Thereby, the engagement ball 531 is disengaged from the engaged portion 521c so that the turning hook body 521 turns as shown in FIG. 10 to have the opening thereof directed downward. Thereby, engagement of the stationary hook 51 and the turning hook 52 is automatically released and the input shaft 3 is put in a state of being movable relative to the output shaft 2 as shown in FIG. 4. Conversely, when the state in which engagement is released, shown in FIG. 10, is to be returned to the state of engagement shown in FIG. 9, the input shaft 3 is moved upward. Then it suffices that the turning hook body 521 be turned in the reverse direction by having the tip end of the return pin 512 pushing up the upper end 521a of the turning hook body 521.

Accordingly, detecting that the output shaft 2 abuts against the pressurized object W the connecting mechanism 5 can automatically release connection of the output shaft 2 and the input shaft 3. Also, after the connecting mechanism 5 releases the connection the input shaft 3 is moved upward to have the stationary hook 51, which is fixed to the upper end of the input shaft 3 abutting against the turning hook 52 of the output shaft 2 whereby the turning hook 52 turns in the reverse direction to enable automatically restoring connection of the output shaft 2 and the input shaft 3.

### (Hydraulic Pressure Mechanism 6)

The hydraulic pressure mechanism 6 is formed so that the second fluid chamber A2, which is defined by the inner peripheral surface 11c of the stationary part body 11 and the outer peripheral surface 21a of the output shaft body 21 to be compartmented above the pressure receiving piston 22, and the third fluid chamber A3, which is defined by the input shaft body 31 and the inner peripheral surface 21b of the output shaft body 21 to be formed below the pressure applying piston 32, are communicated to each other by the communication holes 21d formed on the output shaft body 21 to connect the output shaft 2 and the input shaft 3 hydraulically to each other at all times. As described above, the hydraulic pressure mechanism 6 is set so that a pressure applying area of the pressure applying piston 32 which pressurizes the third fluid chamber A3, is set to be considerably small as compared with a pressure receiving area of the pressure receiving piston 22. Accordingly, in a state in which connection by the connecting mechanism 5 is released, that is, a state, in which the output shaft 2 and the input shaft 3 are movable relative to each other, energization of the pressure applying piston 32 (the input shaft 3) is increased according to Pascal's principle to be transmitted to the pressure receiving piston 22 (the output shaft 2), thus enabling pressurizing a pressurized object W against which the output shaft 2 abuts with high thrust.

Since the communication passages 22a are formed on the pressure receiving piston 22 to provide a communication between the first fluid chamber A1 and the second fluid chamber A2, however, a fluid filled in the hydraulic pressure mechanism 6 (the second fluid chamber A2 and the third fluid chamber A3) is only pushed outside the hydraulic pressure mechanism 6 (the first fluid chamber A1) unless the communication passages 22a are closed, even when pressurization by the pressure applying piston 32 is made, so that it is not possible to realize high-thrust pressurization according to Pascal's principle. Hereupon, the control mechanism 7 described later enables automatically opening and closing the communication passages 22a according to a state of connection between the output shaft 2 and the input shaft 3.

### (Control Mechanism 7)

The control mechanism 7 comprises a valve element 71, a support portion 72, and a fluid path forming portion 73. When the output shaft 2 and the input shaft 3 is connected to each other by the connecting mechanism 5, the valve element 71 is held in a position to maintain the communication passages 22a in communication as shown in FIGS. 1-3. Thereby, as the output shaft 2 is moved at high speed, a fluid can be moved to the second fluid chamber A2 from the first fluid chamber A1. Also, when connection by the connecting mechanism 5 is released, the control mechanism 7 detects flow, which is generated in the hydraulic pressure mechanism 6 when a liquid in the hydraulic pressure mechanism 6 is pushed outside by energization of the input shaft 3, to close the communication passages 22a to shut off the hydraulic pressure mechanism 6 from outside as shown in FIGS. 4-6. Thereby, high-thrust pressurization according to Pascal's principle is made possible.

### (Valve Element 71)

The valve element 71 is actuated by the push force of the flow described above to close the communication passages 22a and arranged inside the hydraulic pressure mechanism 6. As shown in FIG. 6, the valve element 71 includes a shaft-shaped input portion 711 acted by the push force of flow and a plate-shaped closure portion 712 acted by the push force which is applied on the input portion 711 to abut against and cover openings of the communication passages 22a from inside the hydraulic pressure mechanism 6 to close the communication passages 22a. The input portion 711 is supported slidably by a support hole 721 which is formed on the support portion 72 and a front end 711a and a rear end 711b thereof are exposed. The closure portion 712 is fixed to the front end 711a to be opposed to the communication passages 22a. The closure portion 712 is set to be larger in area than the openings of the communication passages 22a and a surface thereof opposed to the openings, that is, a closed surface 712a which covers the openings is formed to be concave.

### (Support Portion 72 and Fluid Path Forming Portion 73)

The support portion 72 is provided integrally on the output shaft 2 and formed with the support hole 721 which is formed to extend through the support portion and to support the input portion 711 slidably. A recess 721a is formed around an opening of the support hole 721, to which the rear end 711b of the input portion 711 is exposed. The rear end 711b of the input portion 711 is put in a state to be exposed to a bottom surface of the recess 721a. The fluid path forming portion 73 is provided integrally on the output shaft 2 to define a passage path 73a as indicated by alternate long and short dash lines in FIG. 6, through which a fluid pushed out from the communication holes 21d by energization of the input shaft 3 is guided to be opposed to the rear end 711b of the input portion 711.

That is, the input portion 711 is arranged at that end of the passage path 73a, against which flow strikes, in a manner to be opposed to the flow. Also, a magnet 722 is provided around an opening of the support hole 721 toward the front end 711a of the input portion 711. The magnet 722 is a holding member which magnetically attracts the closure portion 712 to hold the valve element 71 so as to maintain the communication passages 22a open. The attracting force by the magnet 722 is set to release attraction when a push force generated by flow to have a predetermined value or more acts on the valve element 71.

### (Pressure Absorbing Mechanism 8)

The pressure absorbing mechanism 8 is one by which fluid pressure generated in the first fluid chamber A1 when the output shaft 2 is subjected to high-thrust pressurization is permitted to escape. As shown in FIG. 2, the pressure absorbing mechanism 8 comprises a cylindrical-shaped chamber case 81 connected to the stationary part 1 by a first fluid pipe 81a, a chamber piston 82, which compartments an interior of the chamber case 81 into a fourth fluid chamber A4 and an air chamber A5 and is slidable in the direction of cylinder axis, an air compressor 83 connected to the chamber case 81 by a second fluid pipe 81b and a switching valve 84 provided on an intermediate portion of the second fluid pipe 81b to set the air chamber A5 to either of an atmosphere opened state and a state connected to the air compressor 83.

The fourth fluid chamber A4 is filled with a fluid (oil) and communicated to the first fluid chamber A1. The air chamber A5 is filled with an air and connected to the air compressor 83. The switching valve 84 opens the air chamber A5 to the atmosphere normally but switches the air chamber A5 to a state of connecting to the air compressor 83 when high-thrust pressurization is terminated and driving of the servomotor 43 is stopped. After the switching a high-pressure air is fed into the air chamber A5 to raise an internal pressure in the fourth fluid chamber A4 and the first fluid chamber A1 communicated thereto. This is because the internal pressure as raised pushes up the valve element 71 to open the communication passages 22a.

### (Operations of Hydraulic Pressure Mechanism 6, Control Mechanism 7, and Pressure Absorbing Mechanism 8)

As described above, even when the input shaft 3 is moved downward from an initial state (FIGS. 1 and 2) of being connected to the output shaft 2 the valve element 71 causes the attracting force of the magnet 722 to maintain the communication passages 22a open so that the output shaft 2 can be moved just ahead a position shown in FIG. 3 at high speed without encountering a large resistance.

When the output shaft 2 abuts against the pressurized object W and the input shaft 3 is moved downward in a state in which connection by the connecting mechanism 5 is released, as shown in FIG. 4, the input shaft 3 and the output shaft 2 are moved relative to each other to push the fluid out from the third fluid chamber A3. The third fluid chamber A3 is communicated to the second fluid chamber A2, the first fluid chamber A1, and the fourth fluid chamber A4. Since the air chamber A5 on an opposite side to the fourth fluid chamber A4 with the chamber piston 82 therebetween is opened to the atmosphere, however, the fourth fluid chamber A4 is freely enlarged without resistance. Accordingly, a fluid is pushed out from the third fluid chamber A3 whereby flow of a fluid directed toward the second fluid chamber A2 from the third fluid chamber A3, that is, flow of a fluid directed outside from within the hydraulic pressure mechanism 6 is generated.

As indicated by alternate long and short dash lines in FIG. 6 the flow is guided by the L-shaped passage path 73a a discharge port of which is provided to be directed downward to be directed toward the input portion 711. Since the input portion 711 is arranged at the end of the passage path 73a in a manner to be opposed to the flow it is exerted directly by the push force of the flow to be slid downward so that the closure portion 712 fixed to the front end 711a closes and covers the communication passages 22a. In addition, since the input portion 711 is exposed to the bottom surface of the recess 721a, flow led to the recess 721a acts strongly on the input portion 711. Thus, the hydraulic pressure mechanism 6 is shut off from outside and energization of the input shaft 3 is increased according to Pascal's principle, thus enabling high-thrust pressurization on the output shaft 2.

When high-thrust pressurization is terminated and the servomotor 43 stops the switching valve 84 operates interlocking therewith to permit a high-pressure air to be fed from the air compressor 83 to enlarge the air chamber A5. Thereby, the fourth fluid chamber A4 and the first fluid chamber A1 are compressed and the hydraulic pressure thereby pushes back the closure portion 712 (the valve element 71) which closes the communication passages 22a upward. In particular, the closure portion 712 is set to be larger in area than the communication passages 22a and a surface thereof, which covers the openings of the communication passages 22a is formed to be concave so that the hydraulic pressure efficiently acts to surely push up the valve element 71. The valve element 71 thus pushed up is attracted by the magnet 722 which is embedded in the support portion 72 to be held in a state of putting the communication passages 22a in communication.

Thereafter, when the servomotor 43 is reversely driven to drive the input shaft 3 upward the input shaft is moved until the upper end of the input shaft 3 abuts against a stopper (a peripheral edge of the through-hole 23a of the slide part 23) provided on the output shaft 2, that is, moved to a position just before high-thrust pressurization is begun. In addition, since the pressure applying piston 32 is moved upward to enlarge the third fluid chamber A3, the fluid flows to be drawn into the third fluid chamber A3 through the second fluid chamber A2 from the first fluid chamber A1 as shown in FIG. 7 but the flow is directed to push up the valve element 71 as indicated by alternate long and short dash lines whereby the valve element 71 does not operate in a closing direction.

When the servomotor 43 continues to be driven even after the upper end of the input shaft 3 abuts against the stopper provided on the output shaft 2 the output shaft 2 is pushed up by the input shaft 3 to be moved upward. Since the communication passages 22a provided on the pressure receiving piston 22 are opened the output shaft 2 can be moved at high speed without encountering a large resistance. In addition, since an upper portion of the input portion 711 is covered by the fluid path forming portion 73 a fluid moving to the first fluid chamber A1 from the second fluid chamber A2 at high speed moves keeping away from the input portion 711 as shown in FIG. 8. Accordingly, there is no fear that the communication passages 22a are closed when the output shaft 2 is returned to an original state.

### (Operation of Pressure Apparatus According to One Exemplary Embodiment)

An explanation will be given below to an operation of the whole pressure apparatus according to one exemplary embodiment.

### (High-Speed Movement of Output Shaft 2)

After a pressurized object W is set below the output shaft 2 in a state shown in FIGS. 1 and 2 the servomotor 43 is rotationally driven to move the input shaft 3 downward. Since the input shaft 3 is connected to the output shaft 2 by the connecting mechanism 5 and the communication passages 22a of the pressure receiving piston 22 formed on the output shaft 2 are opened the output shaft 2 is moved downward at high speed while a fluid moves to the second fluid chamber A2 from the first fluid chamber A1.

### (Release of Connection by the Connecting Mechanism 5)

After the output shaft 2 stops high-speed movement just before abutting against a pressurized object W as shown in FIG. 3 it begins downward movement again to abut against the pressurized object W whereby a reaction force on the output shaft 2 is generated from the pressurized object W. Thereby, the turning hook body 521 is turned to be released from engagement with the stationary hook body 511 as shown in FIG. 10. That is, connection by the connecting mechanism 5 is released to bring about a state in which the output shaft 2 and the input shaft 3 is made movable vertically.

(Closure of Communication Passages 22a—Switchover to a State, in which Hydraulic Pressure Mechanism 6 can Operate)

When the input shaft 3 is further energized in a state in which the output shaft 2 and the input shaft 3 is movable relative to each other a fluid in the third fluid chamber A3 is pushed out by the pressure applying piston 32. A push force by the fluid as pushed out causes the valve element 71 of the control mechanism 7 to close the communication passages 22a as shown in FIG. 6 to complete switchover to a state in which the hydraulic pressure mechanism 6 can operate as shown in FIG. 4.

### (High-Thrust Pressurization of Output Shaft 2)

When the input shaft 3 is energized from a state shown in FIG. 4 the input shaft 3 is further moved downward as shown in FIG. 5. The energizing force of the input shaft 3 is transmitted to the pressure receiving piston 22 having a large pressure receiving area from the pressure applying piston 32 having a small pressure applying area through the fluid in the hydraulic pressure mechanism 6 as closed. That is, the energizing force of the input shaft 3 is increased according to Pascal's principle and the output shaft 2 is subjected to high-thrust pressurization.

(Opening of Communication Passages 22a)

When the servomotor 43 is stopped after high-thrust pressurization by the output shaft 2 is terminated switchover by the switching valve 84 is made interlocking therewith to cause a high-pressure air from the air compressor 83 to pressurize the first fluid chamber A1. As shown in FIG. 7, the fluid in the first fluid chamber A1 pushes up the valve element 71 to a position in which the valve element is held by the magnet 722 to put the communication passages 22a in communication.

### (Return of Pressure Applying Piston 32—Restoration of Connection by Connecting Mechanism 5)

By reversely rotating the servomotor 43 in a state in which the communication passages 22a are put in communication it is possible to return the pressure applying piston 32 (the input shaft 3) to a position before high-thrust pressurization shown in FIG. 3 while introducing a fluid into the third fluid chamber A3 from the first fluid chamber A1 as indicated by alternate long and short dash lines in FIG. 7. The input shaft 3 is returned to a position before high-thrust pressurization to bring about a state in which the upper end of the input shaft 3 can push up the output shaft 2 (the slide part 23) and connection of the output shaft 2 and the input shaft 3 by the connecting mechanism 5 is restored.

### (Return of Output Shaft 2)

By driving the servomotor 43 further from a state shown in FIG. 3 the input shaft 3 pushes up the output shaft 2 to return the same to the initial state shown in FIG. 1. In addition, since the communication passages 22a ensures a communication between the first fluid chamber A1 and the second fluid chamber A2 the output shaft 2 can return to its original position at high speed without encountering a large resistance. In this manner, a series of actions by the pressure apparatus according to one exemplary embodiment are terminated.

### (Features of Pressure Apparatus According to One Exemplary Embodiment)

The pressure apparatus according to one exemplary embodiment has the following features.

Firstly, the pressure apparatus has a feature that the output shaft 2 and the input shaft 3 are connected hydraulically to each other at all times and release of connection of the output shaft 2 and the input shaft 3 by the connecting mechanism 5 is detected according to flow of a fluid generated by relative movements of the input shaft 3 and the output shaft 2 to begin an action of the hydraulic pressure mechanism 6 (an increase in an energizing force according to Pascal's principle). Owing to the feature, it is unnecessary to provide an auxiliary valve element which shuts off fluid connection of an output shaft and an input shaft as in the conventional pressure apparatus shown in FIGS. 11-13 in order to detect release of connection of the output shaft 2 and the input shaft 3. Consequently, it is possible to make the pressure apparatus simple in apparatus construction and easy in manufacture.

Also, while it is necessary in the conventional pressure apparatus to return an output shaft to a home position (uppermost end) in order to return the same to an initial position in which an auxiliary valve element can shuts off fluid connection of the output shaft and the input shaft it is unnecessary in the present pressure apparatus to return the output shaft 2 to such position.

Secondly, the pressure apparatus has a feature that a push force provided by flow of a fluid generated by relative movements of the input shaft 3 and the output shaft 2 drives the valve element 71 directly to close the communication passages 22a to switch the hydraulic pressure mechanism 6 over to a state enabling an operation. Owing to the feature when the input shaft 3 and the output shaft 2 move relative to each other switchover to high-thrust pressurization can be made rapidly without the use of external power such as electricity or the like.

Thirdly, the pressure apparatus has a feature that the input portion 711 acted by a driving force (push force) of the valve element 71 is arranged at the end of the passage path 73a in a manner to be opposed to flow of a fluid. Owing to the feature, flow of a fluid pushed out from the third fluid chamber A3 strikes frontally against the input portion 711, thus enabling surely closing the communication passages 22a.

Fourthly, the pressure apparatus has a feature that the input portion 711 is exposed to the bottom surface of the recess formed at the end of the passage path 73a in a manner to be opposed to flow of a fluid. Owing to the feature, a push force provided by flow of a fluid acts strongly on the input portion 711, thus enabling further surely closing the communication passages 22a.

Fifthly, the pressure apparatus has a feature that the plate-shaped closure portion 712 is provided on the valve element 71 and caused by the action of a push force provided by flow of a fluid to abut against the pressure receiving piston 22 in a manner to cover the openings of the communication passages 22a to surely close the communication passages 22a.

Sixthly, the pressure apparatus has a feature that the closure portion 712 is set to be larger in area than the openings of thee communication passages 22a. Owing to the feature, when high-thrust pressurization is made, a fluid in the hydraulic pressure mechanism 6 can strongly close the closure portion 712 and when high-thrust pressurization is terminated, a push force provided by a fluid in the first fluid chamber A1 surely pushes back the closure portion 712, thus enabling surely opening the communication passages 22a.

Seventhly, the pressure apparatus has a feature that a closing surface of the closure portion 712, which covers the openings of the communication passages 22a, is formed to be concave to have a further large pressure receiving area. Owing to the feature, when high-thrust pressurization is terminated a push force provided by a fluid in the first fluid chamber A1 acts on the concave surface having a large pressure receiving area to surely push back the closure portion 712 with a further large force, thus enabling further surely opening the communication passages 22a.

Eighthly, the pressure apparatus has a feature that the valve element 71 is supported slidably by the support portion 72 formed on the output shaft 2 and caused by a push force provided by flow of a fluid to slide to close the communication passages 22a. Owing to the feature, the valve element 71 is simple in structure and can do with less trouble.

Ninthly, the pressure apparatus has a feature that the magnet is provided as a holding member, which holds the valve element 71 so as to maintain the communication passages 22a open until the valve element 71 is acted by a push force of a predetermined value or more. Owing to the feature, it is possible to prevent the communication passages 22a from being closed inadvertently to cause failure in operation and to do with less fear that the holding member itself suffers failure.

Tenthly, the pressure apparatus has a feature that when the input shaft 3 is connected to the output shaft 2 so as to inhibit relative movements and moved downward it is possible to automatically release connection of the output shaft 2 and the input shaft 3 detecting that the output shaft 2 abuts against the pressurized object W. Owing to the feature, it suffices that time required for newly setting a position, in which high-thrust pressurization is begun, be short, and an arrangement can be exchanged in a short period of time even in the case where a point of switchover is moved in exchanging a pressurized object W.

Eleventhly, the pressure apparatus has a feature that detecting that a reaction force is generated on the output shaft 2 in a reverse direction to a direction of movement while the input shaft 3 moves the output shaft 2 downward connection of the output shaft 2 and the input shaft 3 is automatically released. Owing to the feature, even in the case where the output shaft 2 is abnormally locked while the input shaft 3 moves at high speed, connection of the output shaft 2 and the input shaft 3 is released at that point of time so that it is possible to avoid a situation where the connecting mechanism 5 is applied by a large load to break.

Twelfthly, the pressure apparatus has a feature that when a reaction force is generated on the output shaft 2 in a reverse (upward) direction to a direction of movement while the input shaft 3 moves the output shaft 2 downward connection by the connecting mechanism 5 is automatically released by the action of the reaction force. Owing to the feature, there is no need of providing a drive source for release of connection so that it is possible to avoid complication of the apparatus.

Thirteenthly, the pressure apparatus has a feature that when a reaction force is generated on the output shaft 2 in a reverse direction to a direction of movement the stationary hook 51 itself makes use of the reaction force to turn the turning hook 52 to release connection by the connecting mechanism 5. Owing to the feature, there is no need of separately providing a part for turning of the turning hook 52, thus enabling making the number of parts small.

Fourteenthly, the pressure apparatus has a feature that it is possible to regulate a holding force, which holds the turning hook 52 in a state of engaging with the stationary hook 51. Owing to the feature, it is possible to finely regulate a preload applied on a pressurized object W from the output shaft 2 before high-thrust pressurization is begun, depending upon the pressurized object W.

Fifteenthly, the pressure apparatus has a feature that by returning the input shaft 3 to a position before high-thrust pressurization from a state, in which connection by the connecting mechanism 5 is released the stationary hook 51 engages with the turning hook 52 to automatically restore connection of the output shaft 2 and the input shaft 3 by the connecting mechanism 5. Owing to the feature, there is no need of moving the output shaft 2 to the uppermost end in order to restore connection of the output shaft 2 and the input shaft 3 by the connecting mechanism 5.

Sixteenthly, the pressure apparatus has a feature that by returning (upwardly moving) the input shaft 3 from a state in which connection by the connecting mechanism 5 is released the stationary hook 51 fixed to the upper end of the input shaft 3 abuts against the turning hook 52 on the output shaft 2 so that the turning hook 52 is turned in a reverse direction to automatically restore connection of the output shaft 2 and the input shaft 3. Owing to the feature, there is no need of providing a drive source for restoration of connection, so that it is possible to avoid complication of the apparatus.

### (Modification of the Exemplary Embodiment)

While according to the exemplary embodiment, connection by the connecting mechanism 5 is released detecting that the output shaft 2 itself abuts against a pressurized object W, this is not limitative but connection by the connecting mechanism 5 may be released detecting that a member mounted to the output shaft 2 abuts against another member. For example, the case where a moving die of an injection molding machine is mounted to the output shaft 2 and the moving die abuts against a stationary die at the time of closing and the case where a push die of a press machine is mounted to the output shaft 2 and the push die abuts against a bearing die or a press worked material set on the bearing die may be detected.

While according to the exemplary embodiment it is detected on the basis of a reaction force, which the pressurized object W acts on the output shaft 2 that the output shaft 2 abuts against a pressurized object W other detection methods may be used. For example, a load sensor, such as load cell, etc., or an acceleration sensor may be provided on the output shaft 2 and it may be detected on the basis of a change in an output signal from the sensor that the output shaft 2 moving at high speed abuts against a pressurized object W.

While according to the exemplary embodiment, a reaction force acted on the output shaft 2 from the pressurized object W is made use of to release connection by the connecting mechanism 5, the connection may be released by energy supplied from outside according to a change in an output signal from the sensor described above. For example, the connection may be released by an electrically-driven or pneumatically-driven actuator.

While according to the exemplary embodiment, the combination of the stationary hook 51 provided on the input shaft 3 and the turning hook 52 provided on the output shaft 2 is adopted as the connecting mechanism 5 for connection of the output shaft 2 and the input shaft 3, other constructions can be adopted provided that the output shaft 2 and the input shaft 3 can be connected to each other so as not to move relative to each other.

While according to the exemplary embodiment, in order to relieve an impact when the output shaft 2 abuts against the pressurized object W, the input shaft 3 is once stopped just before abutting and then begins movement again, abutting may be of course made decreasing the moving speed without complete stoppage.

Besides, of course, the present disclosure is not limited to the exemplary embodiment but various modifications can be made within a scope without departing from the spirit of the invention.

All patents, patent applications and publications referred to herein are incorporated by reference in their entirety.

1. A pressure apparatus, comprising:
a) stationary part;
b) an output shaft supported on the stationary part to be slidable in an axial direction;
c) an input shaft supported on the output shaft to be slidable coaxially with the output shaft;
d) a drive mechanism capable of moving the input shaft in the axial direction;
e) a connecting mechanism capable of connecting the output shaft and the input shaft to each other so as to inhibit relative movements; and,
f) a hydraulic pressure mechanism which connects the output shaft and the input shaft hydraulically to each other and can increase energization of the input shaft according to Pascal's principle to subject the output shaft to high-thrust pressurization when the output shaft and the input shaft move relative to each other,
wherein, when the input shaft moves the output shaft connected thereto by the connecting mechanism, the connecting mechanism releases connection of the output shaft and the input shaft detecting that the output shaft abuts against a pressurized object.

2. A pressure apparatus, comprising:
a) a stationary part including a hollow cylinder body formed on both ends thereof in a direction of cylinder axis with a first through-hole and a second through-hole;
b) an output shaft including a hollow cylinder body slidably supported by the first through-hole and the second through-hole and defining a first fluid chamber and a second fluid chamber between the output shaft and the stationary part;
c) a pressure receiving piston formed integrally on the output shaft to compartment the first fluid chamber and the second fluid chamber and provided with a communication passage, which provides a communication between the first fluid chamber and the second fluid chamber;
d) an input shaft slidably supported on the output shaft to form a third fluid chamber which is communicated to the second fluid chamber between the input shaft and the output shaft;
d) pressure applying piston integrally formed on the input shaft to expand and contract the third fluid chamber as the input shaft reciprocates, the pressure applying piston having a smaller pressure applying area than a pressure receiving area of the pressure receiving piston;
e) a drive mechanism capable of moving the input shaft in a slide direction;
f) a connecting mechanism capable of connecting the output shaft and the input shaft to each other so as to inhibit relative movements; and,
g) a control mechanism which maintains the communication passage open when connection by the connecting mechanism is provided, and closes the communication passage when connection by the connecting mechanism is released; and,
wherein, when the input shaft moves the output shaft connected thereto by the connecting mechanism, the connecting mechanism releases connection of the output shaft and the input shaft detecting that the output shaft abuts against a pressurized object thereby putting the output shaft in a state capable of high-thrust pressurization.

3. The pressure apparatus of claim 1, wherein detecting that a reaction force in a reverse direction to a direction of movement is generated on the output shaft, the connecting mechanism releases connection of the output shaft and the input shaft.

4. The pressure apparatus of claim 3, wherein the connecting mechanism releases connection of the output shaft and the input shaft due to the action of the reaction force.

5. The pressure apparatus of claim 4, wherein the connecting mechanism engages a first connecting member provided on one of the output shaft and the input shaft and a second connecting member provided on the other with each other to thereby engage the output shaft and the input shaft with each other, and wherein
the first connecting member operates the second connecting member owing to the action of the reaction force to thereby release the engagement.

6. The pressure apparatus of claim 5, wherein the second connecting member comprises a turning hook held by a predetermined holding force so as not to turn in a direction in which engagement thereof with the first connecting member is released and is turned on the first connecting member owing to the action of the reaction force to be released from engagement with the first connecting member.

7. The pressure apparatus of claim 6, wherein the holding force can be regulated.

8. The pressure apparatus of claim 1, wherein by returning the input shaft to a position before high-thrust pressurization is begun from a state in which connection of the output shaft and the input shaft by the connecting mechanism is released, connection by the connecting mechanism is automatically restored.

9. The pressure apparatus of claim 5, wherein by returning the input shaft to a position before high-thrust pressurization is begun from a state in which connection of the output shaft and the input shaft by the connecting mechanism is released, the first connecting member engages with the second connecting member to restore connection by the connecting mechanism.

10. The pressure apparatus of claim 6, wherein by returning the input shaft to a position before high-thrust pressurization is begun from a state in which connection of the output shaft and the input shaft by the connecting mechanism is released, the first connecting member abuts against the second connecting member to turn the second connecting member in a reverse direction to thereby restore engagement between the first connecting member and the second connecting member.

11. The pressure apparatus of claim 1, wherein the hydraulic pressure mechanism is constructed to be switched over to in a state of enabling high-thrust pressurization detecting that connection of the output shaft and the input shaft by the connecting mechanism is released.

12. The pressure apparatus of claim 2, wherein the second fluid chamber and the third fluid chamber are connected hydraulically to each other at all times and when connection by the connecting mechanism is released the control mechanism detects flow of a fluid which is pushed out into the second fluid chamber from the third fluid chamber by energization of the input shaft to close the communication passage.

13. The pressure apparatus of claim 2, wherein detecting that a reaction force in a reverse direction to a direction of movement is generated on the output shaft, the connecting mechanism releases connection of the output shaft and the input shaft.

14. The pressure apparatus of claim 2, wherein by returning the input shaft to a position before high-thrust pressurization is begun from a state in which connection of the output shaft and the input shaft by the connecting mechanism is released, connection by the connecting mechanism is automatically restored.

15. The pressure apparatus of claim 6, wherein by returning the input shaft to a position before high-thrust pressurization is begun from a state in which connection of the output shaft and the input shaft by the connecting mechanism is released, the first connecting member engages with the second connecting member to restore connection by the connecting mechanism.

16. The pressure apparatus of claim 2, wherein the hydraulic pressure mechanism is constructed to be switched over to in a state of enabling high-thrust pressurization detecting that connection of the output shaft and the input shaft by the connecting mechanism is released.
